(19) United States
(12) Patent Application Publication
(10) Pub. No.: US 2013/0330236 A1
(43) Pub. Date: Dec. 12, 2013

(54) SYSTEM FOR INITIATING A GASIFICATION REACTION IN A GASIFIER

(71) Applicants: Anindra Mazumdar, Katy, TX (US); Jay Christopher Schleicher, Houston, TX (US)

(72) Inventors: Anindra Mazumdar, Katy, TX (US); Jay Christopher Schleicher, Houston, TX (US)

(73) Assignee: GENERAL ELECTRIC COMPANY, Schenectady, NY (US)

(21) Appl. No.: 13/494,954

(22) Filed: Jun. 12, 2012

(51) Int. Cl. B01J 7/00; G01N 27/70; F23Q 7/06; B01J 19/02

(52) U.S. Cl. 422/119; 422/199; 422/198; 431/258

(57) ABSTRACT

A system includes a gasifier. The gasifier includes a refractory disposed about a gasification chamber and an enclosure disposed about the refractory. The system also includes an ignition device configured to extend into the gasification chamber and to initiate a gasification reaction within the gasification chamber with a refractory temperature of less than approximately 982° C.

### BACKGROUND OF THE INVENTION

The subject matter disclosed herein relates to gasifiers and, more particularly, to a device for initiating gasification reactions in gasifiers.

A gasifier is designed to generate a synthesis gas, or syngas, by reacting a carbonaceous feedstock with oxygen. After completing a gasification cycle or a tripping of the gasifier occurs, it may be desirable to restart the gasifier. However, the time period to restart the gasifier (e.g., in a hot restart scenario or hot swap scenario) is limited by the temperature within the gasifier. In the event the gasifier temperature falls below the temperature threshold necessary to restart the gasifier a pre-heat burner is required to be installed to heat the gasifier above the threshold for a successful gasification reactions (e.g., light-off) to occur with the feedstock. As a result of this delay, valuable time may be lost for gasifying the feedstock, which in turn may result in lost production of chemicals, lost generation of electricity, and so forth.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a gasifier. The gasifier includes a refractory disposed about a gasification chamber and an enclosure disposed about the refractory. The system also includes an ignition device configured to extend into the gasification chamber and to initiate a gasification reaction within the gasification chamber with a refractory temperature of less than approximately 982° C.

In accordance with a second embodiment, a system includes an ignition device configured to extend into a gasification chamber of a gasifier and to initiate a gasification reaction within the gasification chamber. The ignition device is configured to be electrically heated to initiate the gasification reaction.

In accordance with a third embodiment, a system includes an ignition device configured to extend into a gasification chamber of a gasifier and to initiate a gasification reaction within the gasification chamber with a refractory temperature of less than approximately 982° C. The ignition device is configured to be electrically heated to initiate the gasification reaction.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of an embodiment of a gasifier that includes an ignition device;

FIG. 2 is a cross-sectional side view of an embodiment of an ignition device coupled to a sidewall of an enclosure of the gasifier, taken within line 2-2 of FIG. 1; and

FIG. 3 is a cross-sectional side view of an embodiment of an ignition device integral to a gasification fuel injector, taken within line 3-3 of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for initiating gasification reactions within gasifiers at lower refractory temperatures. In particular, the systems include an ignition device that extends into a gasification chamber to initiate the gasification reaction (e.g., light-off) within the gasification chamber with a refractory temperature of less than approximately 982° C. The ignition device may be coupled to a sidewall or top wall of an enclosure of the gasifier and extend through the refractory into the gasifier chamber. Alternatively, the ignition device may be integral to an injector flange of a gasification fuel injector. The ignition device coupled to the sidewall (or top wall) or integral to the injector flange of the gasification fuel injector may include one or more rods. These rods may be electrically heated (e.g., to a temperature between approximately 982° C. and less than approximately 1650° C.) to initiate the gasification reaction at a lower refractory temperature. The amperage of the one or more rods may be measured and monitored to determine a health reading of the one or more rods. In addition, the rods may be at least partially insulated (e.g., from the sidewall) to block heating of certain components of the gasifier (e.g., sidewall). By enabling the initiation of gasification reactions (e.g., light-off) at lower refractory temperatures, the ignition devices improve the reliability and availability of the unit.

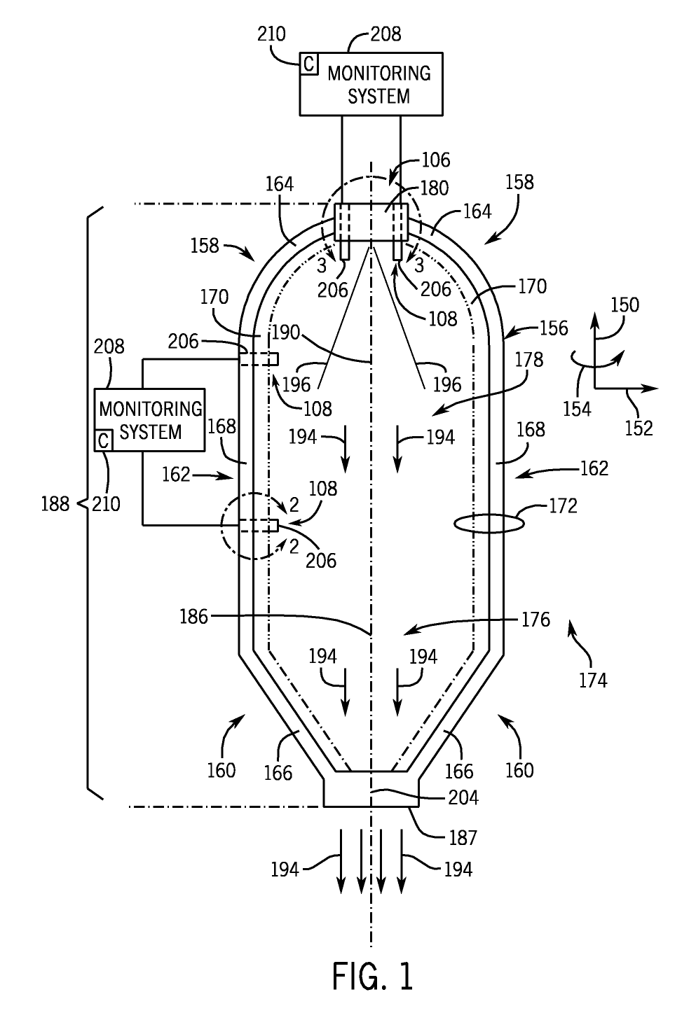

Turning now to the drawings, FIG. 1 is a cross-sectional side view of a gasifier 106 that includes an embodiment of an ignition device 108. The gasifier 106 and ignition device 108 may be a part of a gasification plant or a power plant, such as an integrated gasification combined cycle (IGCC) power plant. However, the disclosed embodiments are not limited to any particular application and thus the disclosed embodiments may be used with any type of application. As discussed in detail below, various embodiments of the ignition device 108 may initiate gasification reactions at a lower refractory temperature. In particular, the ignition devices 108 may initiate gasification reactions with a refractory temperature of less than 982° C. (1800° F.).

The gasifier 106 may have an axial axis or direction 150, a radial axis or direction 152, and a circumferential axis or direction 154. The gasifier 106 includes an enclosure 156, also referred to as the shell, that functions as a housing or outer casing for the gasifier 106. The enclosure 156 includes a first end portion 158 and a second end portion 160. An intermediate portion 162 is defined by the section of the enclosure 156 that lies axially between the first end portion 158 and the second end portion 160. The first end portion 158 and the second end portion 160 include a dome-shaped top wall 164, and a triangular-shaped (e.g., conical shaped) bottom wall 166, respectively. A sidewall 168 (e.g., annular sidewall) parallel to the axis 150 is disposed in the intermediate portion 162 between the top wall 164 and the bottom wall 166.

The illustrated embodiment also includes a refractory 170 lined on the inside of the gasifier wall 164, 166, 168 concentrically disposed inside the enclosure 156. In certain embodiments, the refractory 170 may include multiple layers. The refractory 170 and the enclosure 156 form a wall assembly 172 that separates an exterior 174 of the gasifier 106 from an interior 176 of the gasifier 106. The interior 176 includes a gasification chamber 178, or combustion chamber, where pyrolysis, combustion, gasification, or a combination thereof, may occur. The wall assembly 172 is configured to block heat transfer and leakage of gaseous components from the interior 176 to the exterior 174 during gasification. Additionally, the refractory 170 may be made of a refractory material (e.g., ceramics) and designed to act as a thermal protective layer within the gasifier 106. For example, the refractory 170, or refractory insulating lining, may be made of any material that maintains its predetermined physical and chemical characteristics upon exposure to high temperatures. In addition to protecting the enclosure 156 from high temperature operation, the refractory 170 may control heat loss and serve as a source of heat for a combustion process used to start the gasifier 106. Indeed, the refractory 170 may be heated to a temperature at or above a temperature threshold before the gasifier 106 becomes operable in a gasification mode.

In the embodiment illustrated in FIG. 1, a fuel injector 180 (e.g., gasification fuel injector) is disposed in the top wall 164 of the first end portion 158 of the enclosure 156. The fuel injector 180 is longitudinally offset from an outlet 187 by a distance 188 and includes an injection axis 190 that determines the general orientation of the flow originating from the fuel injector 180. The fuel injector 180 may be configured to inject fuel, oxygen (e.g., air or any oxygen-containing mixture), or a mixture of fuel and oxygen into the gasification chamber 178. For instance, the fuel injector 180 may inject fuel in the form of a carbonaceous feedstock, such as coal, petroleum, or biomass. In fact, the fuel injector 180 may inject any material suitable for the production of synthetic gas, or syngas, via gasification (e.g., organic materials, such as wood or plastic waste). In certain embodiments, the fuel may be a dry fuel or liquid slurry, such as a coal slurry. In other embodiments, the fuel injector 180 may inject a controlled amount of oxygen either alone or in combination with a suitable fuel. In specific embodiments, the fuel injector 180 may include one or more passages. For example, the fuel injector 180 may include one or more fuel passages to inject the fuel and one or more oxygen passages to inject the oxygen.

In the illustrated embodiment, the injection axis 190 is parallel to the axis 150 and perpendicular to the radial axis 152 of the gasifier 106. In other words, the injection axis 190 is parallel to a longitudinal axis 186. Such a feature has the effect of directing a fluid flow emerging from the fuel injector 180 in a generally downward direction (e.g., downstream flow direction), as indicated by arrows 194, through the gasification chamber 178 during use. In certain embodiments, the injection axis 190 may be directed away from the longitudinal axis 186 by an angle between approximately 0 to 45, 0 to 30, 0 to 20, or 0 to 10 degrees. Furthermore, certain embodiments of the fuel injector 180 may provide a divergent spray, e.g., fluid flow originating from the fuel injector 180 may diverge outward toward the side walls 168 in a generally downward direction (e.g., downstream flow direction), as indicated by reference numeral 196.

In the illustrated embodiment of the gasifier 106, the resultant syngas emerges from the gasifier 106 via outlet 187 along a path generally defined by outlet axis 204. That is, the syngas exits the gasifier 106 via a location in the bottom wall 166 of the gasifier 106. However, it should be noted that the gasifier design disclosed herein may be used with a variety of other gasification systems wherein the outlet is not disposed in a bottom wall. For instance, the disclosed embodiments may be used in conjunction with entrained flow gasifiers. In such embodiments, the direction of flow through the gasification chamber 178 may be upward through the gasifier 106, i.e., in a direction opposite arrows 194. In these systems, the resultant syngas may exit an outlet located on or near the top wall 164 of the gasifier 106, while the molten slag may exit through the bottom wall 166. For further example, the disclosed embodiments may be employed in fluidized bed gasifiers. Likewise, the outlet in such devices may be located near the top wall 164 of the gasifier 106 since the direction of flow is generally upward.

The ignition device 108, mentioned above, extends into the gasification chamber 178 of the gasifier 106. The length of the ignition device 108 varies based on the gasifier geometry and location of the ignition device 108 relative to the fuel injector 180. In certain embodiments, the ignition device 108 is coupled to the sidewall 168 of the gasifier 106. In some embodiments, the ignition device 108 is coupled to the top wall 164 of the gasifier 106. In particular, a portion of the ignition device 108 extends through the refractory 170 into the gasification chamber 178. Alternatively or in addition, the ignition device 108 is coupled to the fuel injector 180. For example, the ignition device 106 is integral to an injector flange and extends to and beyond an injector tip of the fuel injector 180 in a parallel manner. The ignition device 108 integral to the fuel injector 180 includes one or more rods 206 (e.g., glow rods). The rods 206 are electrically heated to initiate the gasification reaction within the gasification chamber 178. In certain embodiments, the rods 206 may be heated to a temperature between approximately 982° C. to 1650° C., approximately 982° C. to 1200° C., approximately 1200° C. to 1650° C., approximately 1350° C. to 1400° C., and all subranges therebetween, to initiate the gasification reaction. For example, the rods 206 may be heated to a temperature of 1371° C. (2500° F.) to initiate the gasification reaction. The heated rods 206 enable the initiation of the gasification reaction within the gasification chamber 178 with a refractory temperature ranging from less than approximately 990° C. to less than 970° C. In certain embodiments, the heated rods 206 enable the initiation of the gasification reaction within the gasification chamber 178 with a refractory temperature of less than approximately 982° C. (1800° F.). In certain embodiments, the rods 206 may be partially insulated, for example, to prevent sidewall heating. The rod 206 may be made of high temperatures metals (e.g., tungsten, platinum and/or iridium), alloys, or ceramics. For example, the material of the rod 206 may withstand temperatures within the range of approximately 1090° C. and 2760° C., approximately 1090° C. to 1800° C., approximately 1800° C. to 2760° C., and any other subrange therebetween. The ranges mentioned also apply below.

The rods 206 also enable an amperage measurement to be taken. In particular, the ignition device 108 is coupled to a monitoring system 208 that measures or receives a measurement of the amperage of the rods 206. This enables the monitoring system 208 to monitor the health reading of the rods 206 to determine if the rods 206 are within the desired health reading limits. The monitoring system 208 may include a controller 210 to regulate the monitoring of the health life of the rods 206 as well as the electrical heating of the rods 206. In certain embodiments, the controller 210 may be separate from the monitoring system 208. The desired health reading limits may range from approximately 3 to 5 amps per ignition device 108, but may vary based on the design of the ignition device 108. Thus, an amperage measurement below approximately 3 amps indicates that the rod 206 needs to be replaced. The rods 206 may be replaceable. In addition, the rods 206 may be used for multiple startups until the health reading falls outside of the desired limits. Alternatively, the rods 206 may be sacrificial and replaced after only a single startup. The rods 206 are small enough to ensure no damage if they fall off into the gasifier 106. By enabling the initiation of gasification reactions (e.g., light-off) at lower refractory temperatures, the embodiments of the ignition devices 108 improve the reliability and availability of the unit.

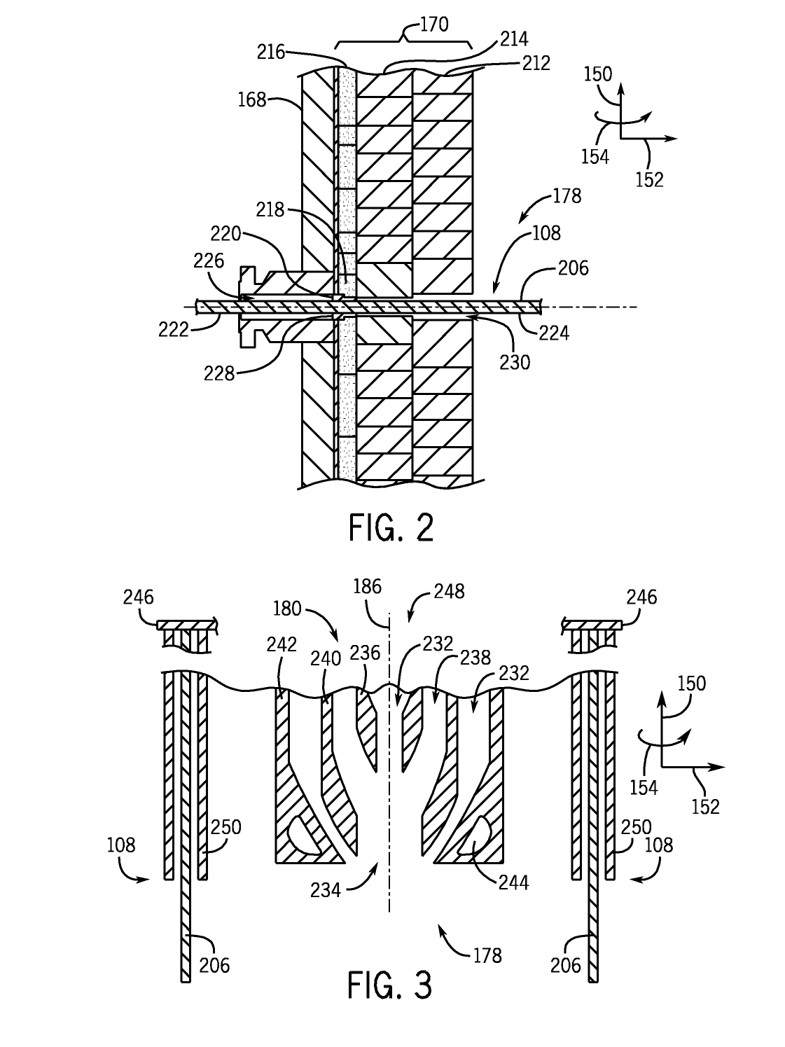

FIG. 2 is a cross-sectional side view of an embodiment of the ignition device 108 coupled to the sidewall 168 of the enclosure 156 of the gasifier 106, taken within line 2-2 of FIG. 1. As depicted, the ignition device 108 includes the rod 206. In certain, embodiments, the ignition device 108 includes one or more rods 206. The rod 206 extends through the sidewall 168 and refractory 170 into the gasification chamber 178. In particular, the rod 206 extends in the radial direction 152 into the gasification chamber 178. The refractory 170 includes multiple layers. In particular, the refractory 170 includes a hot face layer 212 that interfaces with the gasification chamber 178, an isolation layer 214 that isolates the hot face layer 212 from the sidewall 168, and a castable or fiber insulating layer 216. A seal 218 is disposed about the rod 206 proximal to the sidewall 168. An insulator 220 is disposed within the seal 218 separating a first portion 222 and a second portion 224 (e.g., heated portion) of the rod 206. The insulator 220 may provide both electrical and thermal insulation. Thermal insulation prevents the heating of the sidewall 168 by the rod 206. The rod 206 extends through an opening 226 of the sidewall 168, an opening 228 of the insulator 220, and an opening 230 of the refractory 170. As mentioned above, the rod 206 is electrically heated to initiate the gasification reaction within the gasification chamber 178. In particular, the second portion 224 of the rod 206 is electrically heated. The rod 206 may be heated to a temperature between approximately 982° C. to 1650° C., approximately 982° C. to 1200° C., approximately 1200° C. to 1650° C., approximately 1350° C. to 1400° C., and all subranges therebetween, to initiate the gasification reaction. The heated rod 206 enables the initiation of the gasification reaction within the gasification chamber 178 with a refractory temperature of less than approximately 982° C. (1800° F.). The rod 206 may be made of high temperatures metals (e.g., tungsten, platinum, and/or iridium), alloys, or ceramics. For example, the material of the rod 206 may withstand temperatures within the range of approximately 1090° C. and 2760° C.

As described above, the rod 206 may be coupled to the monitoring system 208 and/or controller 210. Electrical wiring from the monitoring system 208 and/or controller 210 is coupled to the first portion 222 of the rod 206. As described above, the electrical wiring may enable the heating of the second portion 224 of the rod 206 as well as monitoring of the amperage measurement of the rod 206. The rod 206 may be replaceable. In addition, the rod 206 may be used for multiple startups. Alternatively, the rod 206 may be sacrificial and replaced after only a single startup. The rod 206 is small enough to ensure no damage if it falls off into the gasifier 106. By enabling the initiation of gasification reactions (e.g., light-off) at lower refractory temperatures, the ignition device 108 improves the reliability and availability of the unit.

FIG. 3 is a cross-sectional side view of an embodiment of the ignition device 108 integral to the fuel injector 180, taken within line 3-3 of FIG. 1. Although one arrangement of passages for the fuel injector 180 will be described, other arrangements are possible depending on the requirements of a particular combustion system. The innermost material passing through the fuel injector 180 is oxygen 232, which is directed to a tip 234 of the fuel injector 180 by a first oxygen passage 236. The first oxygen passage 236 supplies oxygen 232 for combustion downstream of the tip 234 of the fuel injector 180. Oxygen 232 may include, but is not limited to, pure oxygen, oxygen mixtures, and air. The next outermost material is a fuel 238, which is directed to the tip 234 by a fuel passage 240. Thus, the fuel passage 240 surrounds the first oxygen passage 236 in a coaxial or concentric arrangement. The fuel 238 may include a dry fuel, a slurry fuel, a liquid fuel, or any combination thereof. The fuel passage 240 directs the fuel 238 just downstream of oxygen 232 from the first oxygen passage 236 to enhance the mixing of the fuel and oxygen. The next outermost material is oxygen 232, which is directed to the tip 234 of the fuel injector 180 by a second oxygen passage 242. Thus, the second oxygen passage 242 surrounds the fuel passage 240 in a coaxial or concentric arrangement. The second oxygen passage 242 may direct oxygen 232 to the mixture of the fuel 238 and oxygen 232 from the first oxygen passage 236 to produce a fine spray for efficient combustion. The oxygen 232 from the second oxygen passage 242 may also include, but is not limited to, pure oxygen, oxygen mixtures, and air. As shown in FIG. 3, a chamber or channel 244 may be formed in the second oxygen passage 242 near the tip 234 of the fuel injector 180. In certain embodiments, the passages 236, 240, and 242 may be converging or angled toward the longitudinal axis 186 to direct material to the tip 234 and the channel 244 may be disposed in the converging portions of the passages 236, 240, and 242 near the tip 234.

As illustrated, the ignition device 108 is integral to an injector flange 246 at a proximal upstream end 248 of the fuel injector 180 and extends to and beyond the injector tip 234 in the axial direction 150 in a parallel manner. As depicted, the ignition device 108 includes rods 206 that extend in the axial direction 150 into the gasification chamber 178. The rods 206 are at least partially insulated via insulator 250 to prevent heating of other components such as the fuel injector 180 or top wall 164. Each insulator 250 surrounds a portion of each rod 206 in a coaxial or concentric arrangement. As mentioned above, the rods 206 are electrically heated to initiate the gasification reaction within the gasification chamber 178. The rods 206 may be heated to a temperature between approximately 982° C. to 1650° C., approximately 982° C. to 1200° C., approximately 1200° C. to 1650° C., approximately 1350° C. to 1400° C., and all subranges therebetween, to initiate the gasification reaction. The heated rods 206 enable the initiation of the gasification reaction within the gasification chamber 178 at a refractory temperature of less than approximately 982° C. (1800° F.). The rods 206 may be made of high temperatures metals (e.g., tungsten), alloys, or ceramics. For example, the material of the rods 206 may withstand temperatures within the range of approximately 1093° C. and 2760° C.

As described above, the rods 206 may be coupled to the monitoring system 208 and/or controller 210 via electrical wiring to enable the heating of the rods 206 as well as monitoring of the amperage measurement of the rods 206. The rods 206 may be replaceable. In addition, the rods 206 may be used for multiple startups. Alternatively, the rod 206 may be sacrificial and replaced after only a single startup. The rods 206 are small enough to ensure no damage if they fall off into the gasifier 106. By enabling the initiation of gasification reactions (e.g., light-off) at lower refractory temperatures, the ignition device 108 improves the reliability and availability of the unit.

Technical effects of the disclosed embodiments include providing systems for initiating gasification reactions within gasifiers 106 at lower refractory temperatures. In particular, the systems include the ignition device 108 that extends into the gasification chamber 178 to initiate the gasification reaction (e.g., light-off) within the gasification chamber 178 with a refractory temperature of less than approximately 1204° C. (2200° F.). In certain embodiments, the ignition device 108 initiates the gasification reaction at a refractory temperature of less than approximately 982° C. The ignition device 108 may include electrically heated rods 206 integral to the injector flange 246 of the fuel injector 180 or rods 206 coupled to the sidewall 169 that extend through the refractory 170 into the gasification chamber 178. By enabling the initiation of gasification reactions (e.g., light-off) at lower refractory temperatures, the ignition device 108 improves the reliability and availability of the unit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gasifier, comprising:
a refractory disposed about a gasification chamber; and
an enclosure disposed about the refractory; and
an ignition device configured to extend into the gasification chamber and to initiate a gasification reaction within the gasification chamber with a refractory temperature of less than approximately 982° C.

2. The system of claim 1, wherein the enclosure comprises at least one sidewall, wherein the ignition device is coupled to the at least one sidewall, and a portion of the ignition device extends through the refractory into the gasification chamber.

3. The system of claim 1, comprising a gasification fuel injector, wherein the ignition device is coupled to the gasification fuel injector.

4. The system of claim 3, wherein the gasification fuel injector comprises an injector flange and an injector tip, and the ignition device is integral to the injector flange and extends to the injector tip.

5. The system of claim 1, wherein the ignition device comprises at least one rod that extends into the gasification chamber to initiate the gasification reaction, wherein the at least rod is configured to be electrically heated to initiate the gasification reaction.

6. The system of claim 5, wherein the at least one rod is configured to enable amperage measurement of the at least one rod.

7. The system of claim 7, comprising a monitoring system configured to monitor a health reading of the at least one rod via the amperage measurement.

8. The system of claim 5, wherein the at least one rod is configured to withstand temperatures within the range of approximately 1090° C. and 2760° C.

9. The system of claim 1, wherein the at least one rod is electrically heated to a temperature between 982° C. and 1650° C. to initiate the gasification reaction.

10. A system, comprising:
an ignition device configured to extend into a gasification chamber of a gasifier and to initiate a gasification reaction within the gasification chamber, wherein the ignition device is configured to be electrically heated to initiate the gasification reaction.

11. The system of claim 10, wherein the ignition device is configured to initiate the gasification reaction within the gasification chamber with a refractory temperature of less than approximately 982° C.

12. The system of claim 10, wherein the ignition device is configured to couple to a sidewall or top wall of an enclosure of the gasifier, and a portion of the ignition device is configured to extend through a refractory of the gasifier into the gasification chamber.

13. The system of claim 10, wherein the ignition device is configured to be integral to an injection flange of a gasification fuel injector and to extend to a tip of an injector tip of the gasification fuel injector.

14. The system of claim 10, wherein the ignition device comprises at least one rod, and the at least one rod is configured to withstand temperatures within the range of approximately 1090° C. and 2760° C.

15. The system of claim 14, wherein the at least one rod is electrically heated to a temperature between 982° C. and 1650° C. to initiate the gasification reaction.

16. A system, comprising:
an ignition device configured to extend into a gasification chamber of a gasifier and to initiate a gasification reaction within the gasification chamber with a refractory temperature of less than approximately 982° C., wherein the ignition device is configured to be electrically heated to initiate the gasification reaction.

17. The system of claim 16, wherein the ignition device is configured to couple to a sidewall or top wall of an enclosure of the gasifier, and a portion of the ignition device is configured to extend through a refractory of the gasifier into the gasification chamber.

18. The system of claim 16, wherein the ignition device is configured to be integral to an injection flange of a gasification fuel injector and to extend to a tip of an injector tip of the gasification fuel injector.

19. The system of claim 16, wherein the ignition device comprises at least one rod, and the at least one rod is configured to withstand temperatures within the range of approximately 1090° C. and 2760° C.

20. The system of claim 19, wherein the at least one rod is electrically heated to a temperature between 982° C. and 1650° C. to initiate the gasification reaction.
